(19) United States
(12) Patent Application Publication
(10) Pub. No.: US 2010/0250034 A1
(43) Pub. Date: Sep. 30, 2010

(54) METHOD OF MANAGING AIRCRAFT WARNINGS, AND A DEVICE FOR IMPLEMENTING SAID METHOD

(75) Inventors: Pierre BOUCHARD, Gignac-La-Nerthe (FR); Valérie JUPPET, Marignane (FR); Alexander REICH, Munich (DE)

Correspondence Address: YOUNG & THOMPSON, 209 Madison Street, Suite 500, Alexandria, VA, 22314, US

(73) Assignee: EUROCOPTER, Marignane (FR)

(21) Appl. No.: 12/726,588

(22) Filed: Mar. 18, 2010

(30) Foreign Application Priority Data
Mar. 31, 2009 (FR) 09 01557

(51) Int. Cl. G06F 19/00; G01C 21/00

(52) U.S. Cl. 701/14; 340/971

(57) ABSTRACT

A method of managing warnings in an aircraft, includes:
receiving information signals associated with a malfunction or with conditions requiring the pilot to be informed;
preparing warning instructions as a function of the context and forwarding the warning instructions to visual and/or audible indicator elements;
allocating a visual and/or audible warning to each of the warning instructions; and
using visual indicator elements to display the visual warnings and using audible indicator elements to emit the audible warnings.

### FIELD OF THE INVENTION

The present invention relates to a method of managing warnings activated during the operation of an aircraft, and in particular a helicopter.

### BACKGROUND OF THE INVENTION

Activating a set of warnings, e.g. during a stage of flight, often corresponds to a situation in which the pilot is highly stressed. It is not unusual for different audible and visual warnings to be activated simultaneously. This requires the pilot to analyze them quickly and to undertake one or more corrective actions. The pilot is thus confronted with a problem that consists in understanding the state of the systems and in planning which actions need to be carried out as a priority, and which in the medium term. In addition, with known systems, the pilot may be confronted with various different audible warnings all sounding at once, which can then make them difficult to identify.

Below, the following concepts are distinguished:

information signals associated with a malfunction or with conditions requiring the pilot to be informed;

warning instructions associated with the identification of a message or a state that enables a visual and/or audible warning to be obtained from information signals; and

visual and audible warnings.

Furthermore, the search for increased aircraft safety has led to warning systems becoming more numerous and consequently to there being a greater number of indicator means suitable for informing the pilot. Nevertheless, it is not desirable to increase the number of pieces of equipment that display warnings, in order to avoid making the pilot's task more complicated.

By way of example, document U.S. Pat. No. 4, 635, 030 describes a device for processing warnings in an aircraft. That device enables a certain number of steps of a warning management method in accordance with the invention to be implemented. That document describes allocating a priority rank to each warning and displaying the two, three, or four warnings having the highest priority ranks. In addition, that document describes using a color code (red, amber, green) and a display that is localized on a screen as a function of said code. That document allocates a priority rank to all warnings, which are then displayed successively as a function of priority rank.

Document FR 2 296 230 also discloses a warning device for vehicles, that device serving to inform the driver of anomalous operation or utilization. An audible warning signal at a frequency that depends on the criticality of the warning is emitted simultaneously with a visual signal such as a flashing light. The system described also serves to allocate a degree of urgency to different warnings. Color codes are allocated to different visual warnings.

### OBJECT AND SUMMARY OF THE INVENTION

The object of the present invention is consequently to propose a novel method of treating warnings that avoids the above-mentioned drawbacks and that enables said warnings to be managed effectively in compliance with the criticality of the situation.

Another object of the invention seeks to propose a novel method of processing warnings that enables a dialog to be defined, e.g. between a computer and visual and audible indicator means for displaying and/or emitting warnings on the basis of determined logic that is based on priorities.

Another object of the present invention seeks to propose a method of processing warnings that consists in emitting different audible warnings in succession or in superposed manner, depending on the natures of said warnings. Advantageously, when emitting a plurality of audible messages, it is possible to adjust relative sound power levels.

Another object of the present invention seeks to propose a method of processing warnings that consists in differentiated management of at least some of the visual and audible warnings while they are being prepared and/or processed.

Another object of the present invention seeks to provide a device that is simple and reliable and that enables the novel processing method to be implemented.

The objects given to the invention are achieved with the help of a warning management method in an aircraft, the method consisting in:

detecting information signals, e.g. coming from sensors and associated with malfunctions or conditions requiring the pilot to be informed;

preparing warning instructions as a function of the context and forwarding said warning instructions to visual and/or audible indicator means;

allocating at least one visual and/or audible warning to at least some of the warning instructions;

allocating a priority class to at least the visual warnings;

allocating a priority rank to each visual warning and to each audible warning, said priority rank depending for example on the system to which the warning instruction relates or on the importance of the system in the aircraft;

recording a maximum number T of visual and/or audible warnings in a warning list by priority rank;

selecting a maximum N of visual warnings consistent with the operation of the aircraft, presenting the highest priority classes or by default the highest priority ranks, where N is less than or equal to T, and in displaying the N corresponding warnings using the visual indicator means; and

selecting at least one audible warning firstly presenting the highest priority rank and secondly consistent with the operating context of the aircraft, and in emitting the corresponding audible warning using the audible indicator means.

In an implementation, the method in accordance with the invention consists in transmitting the information signals to a processor module of the computer kind, which module processes said information signals with the help of an algorithm.

In an implementation, the method in accordance with the invention consists in displaying the visual warning and/or in emitting at least one audible warning, while waiting for an acknowledgment or processing by the pilot.

In an implementation, the method in accordance with the invention consists in allocating e.g. a lower priority rank to those warnings that are acknowledged by the pilot.

In an implementation, the method in accordance with the invention consists in eliminating from the list of warnings, visual and/or audible warnings that have been processed by the pilot.

A warning being acknowledged means that the pilot has taken cognizance of said warning, e.g. by pressing on a control member such as a switch, etc., in order to indicate that the pilot has taken account of the warning.

In an implementation, the method in accordance with the invention consists in ensuring that an acknowledgment is consistent with the visual and audible warnings by inhibiting the acknowledgment of visual warnings while an audible warning having no visual equivalent is activated. This ensures that the management of warnings is made safer.

In an implementation, the method in accordance with the invention consists in verifying consistency between the visual and audible warnings before activating them. By way of example, this makes it possible to avoid warnings being activated simultaneously that might induce pilot error concerning which corrective actions need to be undertaken.

In an implementation, the method in accordance with the invention consists in adapting the warning instructions to the situation or the context of the aircraft, in order to eliminate or to concatenate warnings, should that be appropriate. In practice, this amounts to preparing a modified warning when a plurality of warnings of the same type appear. Thus, a “system 1 failure” warning appearing simultaneously with a “system 2 failure” warning will generate a “system 1+2 failure” warning.

By way of example, mention may be made of a warning instruction associated with a left engine fire and a warning instruction associated with a right engine fire, which together generate a concatenated common warning.

In an implementation, the method in accordance with the invention consists in defining subsets of malfunctions or conditions for which warning instructions associated with distinct events give rise to visual and/or audible warnings that are identical.

By way of example, this may result from an electrical problem and a hydraulic problem, each of which has the same consequence for the aircraft.

In an implementation, the method in accordance with the invention consists in selecting the language for communication between the visual and audible indicator means and the pilot.

In an implementation, the method in accordance with the invention consists in emitting audible warnings successively one after another, or in alternation, or by adapting sound levels, as a function of the priority ranks allocated to said warnings.

In another implementation, the method in accordance with the invention consists in emitting audible warnings simultaneously, providing said audible warnings are of different kinds, such as for example a sound warning and a voice warning, providing their priority ranks make that possible.

In an implementation, the method in accordance with the invention consists in updating the list of warnings periodically, e.g. every 50 milliseconds.

The objects given to the present invention are also achieved with the help of an on-board device for processing warnings to implement the above-described method, the device comprising:

a concentrator for concentrating data, the concentrator being constituted by a piece of equipment or a module incorporated in a piece of equipment, serving to acquire information signals from various systems and pieces of equipment of the aircraft;

a warning manager constituted by a module incorporated in or separate from the data concentrator, for processing information signals and for generating warning instructions, while taking account of the context of the aircraft;

visual indicators for displaying the visual warnings; and

audible indicators for emitting the audible warnings.

The objects given to the present invention are also achieved with an aircraft, such as a helicopter, including an on-board device as described above.

### BRIEF DESCRIPTION OF THE DRAWINGS

The invention and its advantages appear in greater detail from the following description of an implementation given by way of illustration with reference to the accompanying figures, in which:

FIG. 1 is a diagrammatic view of an embodiment of an on-board device for processing warnings in accordance with the invention shown inserted in its technical environment;

FIG. 2 is a diagram of an embodiment of an on-board device for processing warnings in accordance with the invention; and

FIG. 3 is a flowchart of an embodiment of the warning management method in accordance with the invention.

### MORE DETAILED DESCRIPTION

Elements that are structurally and functionally identical and present in two or more distinct figures are given the same reference in each of them. The same applies for identical method steps.

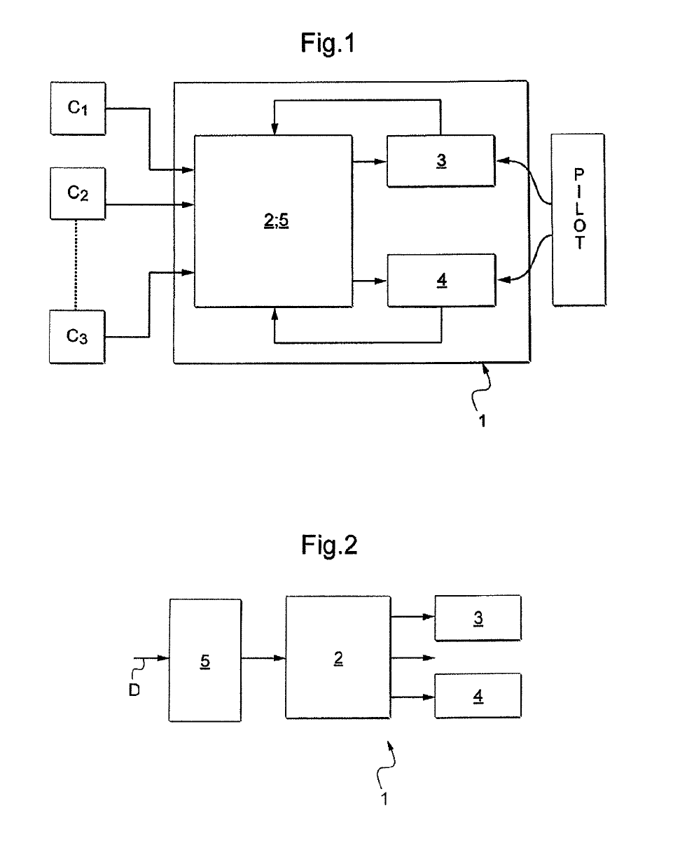

The present invention relates to an on-board device 1 for processing warnings. An embodiment of such a device 1 is shown in FIGS. 1 and 2.

The device 1 in accordance with the invention includes a warning manager 2, e.g. constituted by a module for processing warning instructions and for generating warnings that take the context of the aircraft into account.

The device 1 in accordance with the invention also includes visual indicator means 3 for displaying visual warnings V and audible indicator means 4 for emitting audible warnings S.

The device 1 in accordance with the invention also includes a concentrator 5 of data D, constituted by a piece of equipment or by a module incorporated in a piece of equipment, serving to acquire information from various systems and pieces of equipment of the aircraft.

The warning manager 2 may, for example, either be incorporated within or separate from the data concentrator 5.

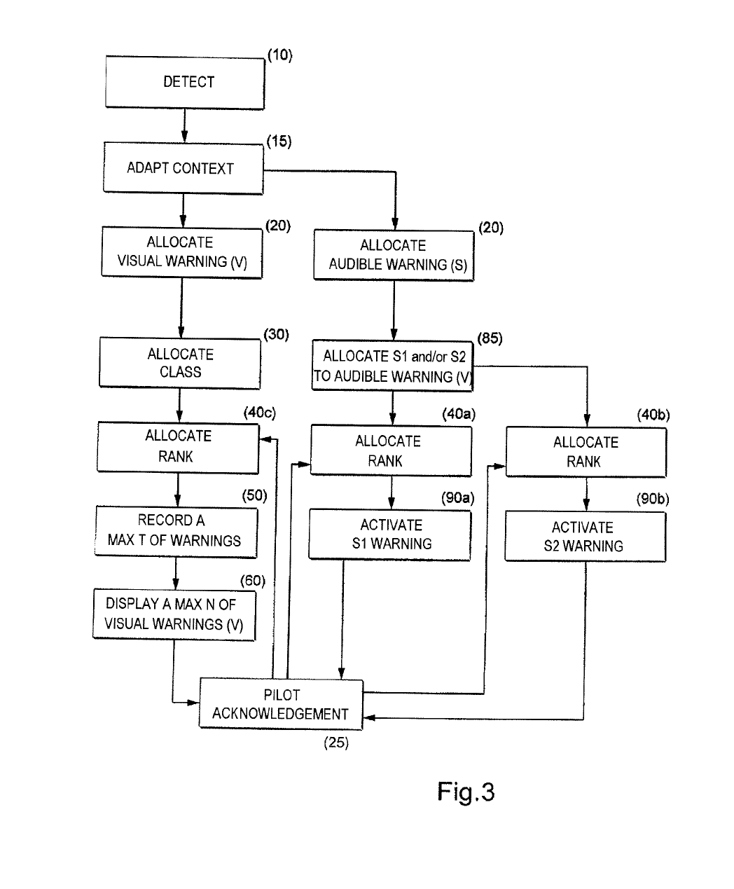

The method in accordance with the invention for managing warnings in an aircraft, as shown in FIG. 3, consists in receiving information signals in the form of data D, e.g. coming from sensors C1, C2, C3. These signals are associated with respective malfunctions or conditions requiring the pilot to be informed.

These information signals are subsequently forwarded to a module or equipment constituting the concentrator 5 of data D. The warning manager 2 uses a processor module to process said information signals with the help of an algorithm for preparing and generating warning instructions as a function of the context of the aircraft. Thereafter, the warning manager 2 transmits the warning instructions to the visual indicator means V and/or the audible indicator means S.

Depending on circumstances, the indicator means V, S are activated to display and/or emit at least one warning depending on the warning instructions and on the context of the aircraft.

The term “visible warning”, or “audible warning”, is used to mean displaying or emitting messages concerning faults in states of a system or of equipment, or excursions beyond the normal utilization perimeter of the aircraft, or merely providing information about the state of a system or equipment of the aircraft. Aircraft contexts may relate to stages of flight, start-up stages, mission stages, e.g. tactical stages, or stages associated with particular missions.

A warning “instruction” should be understood as being the identification of a message or a state that enables a visual and/or audible warning to be obtained on the basis of information signals. The warning instruction may be associated with a fault of a system or of equipment, with an excursion beyond the perimeter or with a particular state of a mission or equipment. Excursions beyond a perimeter may be associated with the context of the aircraft.

An implementation of the method in accordance with the invention is shown in FIG. 3.

In a step 10 of the method, information signals are detected coming from systems or pieces of equipment of the aircraft.

Thereafter, in a step 15, the method serves to prepare corresponding warning instructions, and where appropriate to combine or concatenate said warning instructions should that be advisable, given the context of the aircraft.

In a step 20, the method consists in allocating a visual and/or audible warning V and/or S to each warning instruction.

Acknowledgment, in a step 25 of the method, consists in allocating a lower priority to acknowledged warnings, possibly leading to eliminating audible emission thereof or to reducing audible volume, and to eliminating display thereof, at least temporarily. By way of example, acknowledgment acts at least on a priority rank given to the visual or audible warning. In the example of FIG. 3, acknowledgment acts on the priority ranks of the warning. In another implementation (not shown), it is possible to envisage that acknowledgment in step 25 acts directly on the allocations of the visual and/or audible warnings.

On the assumption that at least one visual warning has been allocated to a warning instruction, in a step 30 a priority class is initially allocated to each visual warning. By way of example, these classes comprise an “imminent danger” class, an “attention” class, and an “information” class. Sub-classes may also be envisaged for each class.

By way of example, the display of these classes makes use of a color code. A visual warning in the “imminent danger” class thus represents a visual warning of red color whereas a visual warning in particular in the “attention” class represents a visual warning of amber color.

Warnings of the “imminent danger” class require the pilot to take them into account or act immediately, whereas warnings in the “attention” class may possibly require no more than deferred action. Warnings in the “information” class represented signaling or returning information, e.g. about certain states of the aircraft. The allocation of classes is preferably not affected by an acknowledgment operation on the part of the pilot.

Thereafter, in a step 85, an audible signal type S1 or S2 is allocated to each audible warning. An audible signal of type S1 is for example of the sound kind and an audible signal of type S2 is for example of voice kind.

Depending on the pilot's acknowledgment, as takes place in a step 25, steps 40a, 40b, and 40c serve subsequently to allocate a priority rank to each warning. The predefined order in which warnings are classified by using priority ranks depends in particular on the type of the warning.

By way of example, the class and the priority rank depend on the system to which the warning relates or on the importance of the system in the aircraft, or on the reactivity required of the pilot. The class and the priority rank are preferably easily modifiable using configuration means in order to be adapted to specific features of a given aircraft.

In a step 50, a maximum number T of visual warnings V is recorded in a warning list and in a step 60, a maximum number N of visual warnings V is selected, which selected warnings are displayed by means of the visual indicators 3. N is an integer that is less than or equal to the integer T.

On the assumption that an audible warning S has been allocated to a warning instruction and that said warning is consistent with the operating context of the aircraft, in a step 90a or 90b, an audible warning of type S1 or S2 is emitted using sound indicators 4.

In an implementation in accordance with the invention, the method consists, in step 25, in ensuring that an acknowledgment made by the pilot is consistent with the visual and audible warnings V and S, by inhibiting the acknowledgment of visual warnings V while an audible warning S that has no visual equivalence is activated. This produces a complementary hierarchy of warnings that can be important under critical circumstances.

The management method in accordance with the invention also consists, in step 25, in acknowledging the visual warnings V and the audible warnings S displayed and emitted in steps 60 and 90a and/or 90b. The acknowledgment undertaken by the pilot thus makes it possible, for example, to modify the priority ranks of activated warnings, or for example the sound volumes of audible warnings. Certain warnings may thus be deactivated, at least temporarily.

The present invention applies to any aircraft, whether a helicopter or otherwise, that includes an on-board device 1 in accordance with the invention.

Naturally, the present invention may be subjected to numerous variations as to its implementation. Although several embodiments are described, it will readily be understood that it is not conceivable to identify exhaustively all possible embodiments. It is naturally possible to envisage replacing any of the means described by equivalent means or any of the steps described by an equivalent step, without going beyond the ambit of the present invention.

What is claimed is:

1. A method of managing warnings in an aircraft, the method consisting:
in a step (10), in detecting information signals, e.g. coming from sensors (C1, C2, C3) and associated with malfunctions or conditions requiring the pilot to be informed;
in a step (15), in preparing warning instructions as a function of the context and forwarding said warning instructions to visual and/or audible indicator means (3, 4);
in a step (20), in allocating at least one visual and/or audible warning (V, S) to at least some of the warning instructions;
in a step (30), in allocating a priority class to at least the visual warnings (V);
in a step (40a, 40b, 40c), in allocating a priority rank to each visual warning (V) and to each audible warning (S), said priority rank depending for example on the system to which the warning instruction relates or on the importance of the system in the aircraft;
in a step (50), in recording a maximum number T of visual and/or audible warnings (V, S) in a warning list by priority rank;
in a step (60), in selecting a maximum N of visual warnings (V) consistent with the operation of the aircraft, presenting the highest priority classes or by default the highest priority ranks, where N is less than or equal to T, and in displaying the N corresponding warnings using the visual indicator means (3); and
in a step (90a, 90b), in selecting at least one audible warning (S) firstly presenting the highest priority rank and secondly consistent with the operating context of the aircraft, and in emitting the corresponding audible warning using the audible indicator means (4).

2. A method according to claim 1, consisting in transmitting the information signals to a processor module of the computer kind, which module processes said information signals with the help of an algorithm.

3. A method according to claim 1, consisting in displaying the visual warning (V) and/or in emitting at least one audible warning (S), while waiting for an acknowledgment or processing by the pilot.

4. A method according to claim 3, consisting, in a step (25), in allocating e.g. a lower priority rank to those warnings (S, V) that are acknowledged by the pilot.

5. A method according to claim 3, consisting in ensuring that an acknowledgment consists in step (25) in ensuring that an acknowledgment is consistent with the visual and audible warnings (V, S) by inhibiting the acknowledgment of visual warnings (V) while an audible warning (S) having no visual equivalent is activated.

6. A method according to claim 3, consisting in eliminating from the list of warnings, visual and/or audible warnings (S, V) that have been processed by the pilot.

7. A method according to claim 1, consisting in verifying consistency between the visual and audible warnings before activating them.

8. A method according to claim 1, consisting in defining subsets of malfunctions or conditions for which warning instructions associated with distinct events give rise to visual and/or audible warnings (V, S) that are identical.

9. A method according to claim 1, consisting in emitting audible warnings (S) successively one after another, or in alternation, or by adapting sound levels, as a function of the priority ranks allocated to said warnings.

10. A method according to claim 1, consisting in emitting audible warnings (S) simultaneously, providing said audible warnings (S) are of different kinds, such as for example a sound warning and a voice warning, providing their priority ranks make that possible.

11. A method according to claim 1, consisting in updating the list of warnings periodically, e.g. every 50 milliseconds.

12. An on-board device for processing warnings to implement the method in accordance with claim 1, the device comprising:
a concentrator (5) for concentrating data (D), the concentrator being constituted by a piece of equipment or a module incorporated in a piece of equipment, serving to acquire information signals from various systems and pieces of equipment of the aircraft;
a warning manager (2) constituted by a module incorporated in or separate from the data concentrator (5), for processing information signals and for generating warning instructions, while taking account of the context of the aircraft;
visual indicators (3) for displaying the visual warnings (V); and
audible indicators (4) for emitting the audible warnings (S).

13. An aircraft of the helicopter kind including an on-board device in accordance with claim 12.
